(19) United States
(12) Patent Application Publication
(10) Pub. No.: US 2009/0031612 A1
(43) Pub. Date: Feb. 5, 2009

(54) NON-CHEMICAL FLY REPELLANT DEVICE

(75) Inventors: April Hubbard, Collierville, TN (US); Reginald Hubbard, Collierville, TN (US)

Correspondence Address: APRIL J. HUBBARD, 9332 BREAKSTONE COVE, COLLIERVILLE, TN, 38017, US

(73) Assignee: Eric Heine

(21) Appl. No.: 11/830,773

(22) Filed: Jul. 30, 2007

(51) Int. Cl. A01M 29/00; A01M 1/04; A01M 1/00

(52) U.S. Cl. 43/132.1; 359/584; 43/113

(57) ABSTRACT

This invention relates to a non-chemical device for repelling flies from a building entrance or outside area. The device repels flies from such environments using the prismatic effect of ambient light passing through the clear rigid housing of the device, through the fluid contained within, and reflecting off a reflective element within the fluid. The device may be constructed such that a vacuum is created within the housing in order to prevent the growth of aerobic organisms within the device.

### BACKGROUND

1. Field of Invention

The invention relates to a non-chemical device for repelling flies from a building entrance or outside area. The device repels flies from such environments using the prismatic effect of ambient light passing through the clear rigid housing of the device, through the fluid contained within, and reflecting off a reflective element within the fluid. The device may be constructed such that a vacuum is created within the housing in order to prevent the growth of aerobic organisms within the device.

2. Description of Prior Art

Prior to the current invention, means of repelling flies included chemical agents or physical barriers to prevent the intrusion of flies to an area. Flyswatters, birds, flypaper, toxic chemicals, and electronic devices have all been used with mixed success, mostly by killing those flies that entered the area. Along with being unsightly, these methods can create contamination in areas such as surgical suites or food preparation areas. These methods also lack the safety required for use in areas where children may be present. A need exists for a fly repellant device that requires no chemicals, no electricity or power supply, no human effort or vigilance, and can be used in a private or commercial location, especially those with children present, at a nominal cost and without environmental impact.

The following United States patents were discovered and are disclosed within this application for utility patent. All relate to insect repelling or extermination devices using light or chemical means. In U.S. Pat. No. 5,607,711 to Langunas-Solar, a non-chemical, non-residue method of controlling pests, pathogens, and organisms found in food products is disclosed using ultra-short pulses of emitted ultraviolet light, heating the insect but not effecting the food product. A trap using light as an attractant is disclosed in U.S. Pat. No. 5,505,017 to Nelson, et al. which lures the insect into the device using the reflected and radiated light, where the insect is trapped on a surface. A liquid attractant to an insect trap is disclosed in U.S. Pat. No. 5,490,349 to Muramatsu, which has a nipple entry attracting the insect into the device after which the insect is unable to find egress from the device, the liquid being of the type to attract insects of the nature of those being trapped. “Evil” destruction caused by insects is thwarted by a light shielding agent which absorbs light normally attractive to insects, the liquid shielding agent applied to normally transparent surface through which light is passed, as disclosed in U.S. Pat. No. 4,919,926 to Watanabe, et al. The use of a translucent shield leaching an insecticide to its surface through the heat of ambient light, while converting such ambient light into a spectrum attracting flying insects is disclosed in U.S. Pat. No. 4,901,980 to Sherman. A clear envelope hung from the edge of a covered area filled with clear liquid is disclosed in U.S. Pat. No. 6,543,180. This invention uses the prismatic effect of refracted ambient light passing through a liquid to repel flies, however it is not an optimal design for fly repellant using this effect.

### SUMMARY

The primary objective of the invention is to provide a device which repels flies without chemical means, without contact, and in an aesthetic manner. The current invention uses the prismatic effect of refracted ambient light through a clear liquid to repel flies or other flying insects having the similar visual functions as a fly. The invention is a clear container hung from the entrance of a building or placed within an outdoor area, which contains a clear fluid and one or more metallic elements. This invention differs from the prior art disclosed in U.S. Pat. No. 6,543,180 in that it is a structurally rigid device. The transparent envelope disclosed in the prior art is subject to structural degradation due to prolonged exposure to ultraviolet radiation from the sun, in addition to the weight from the liquid contained within. It may not be able to withstand high winds, and cannot be used in a non-hanging manner. In addition, it does not contain metallic elements necessary for the maximum production of the prismatic effect. More specific features and advantages obtained in view of those features will become apparent with reference to the DETAILED DESCRIPTION OF THE INVENTION, appended claims, and accompanying drawing figure.

### DETAILED DESCRIPTION OF THE DRAWINGS

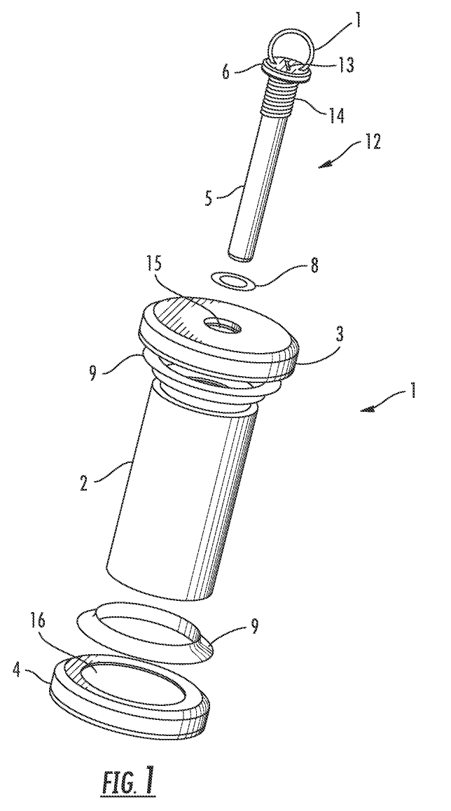

FIG. 1 is an exploded perspective view of the invention prior to assembly.

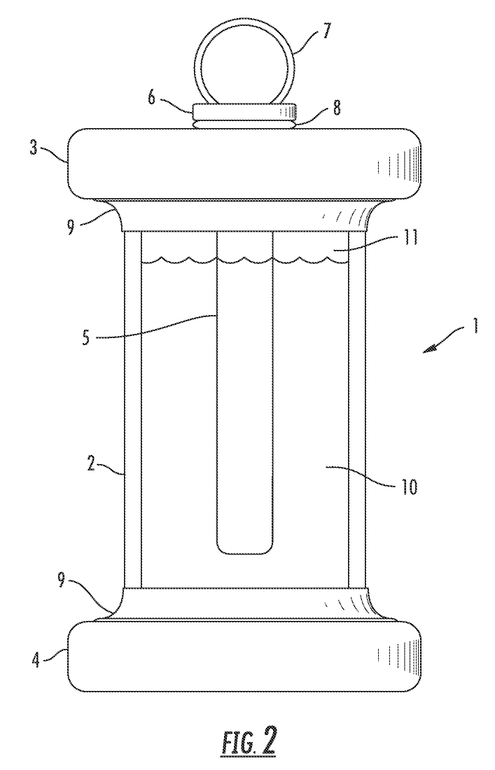

FIG. 2 is a front view of the invention.

FIG. 3 is a front view of the second embodiment.

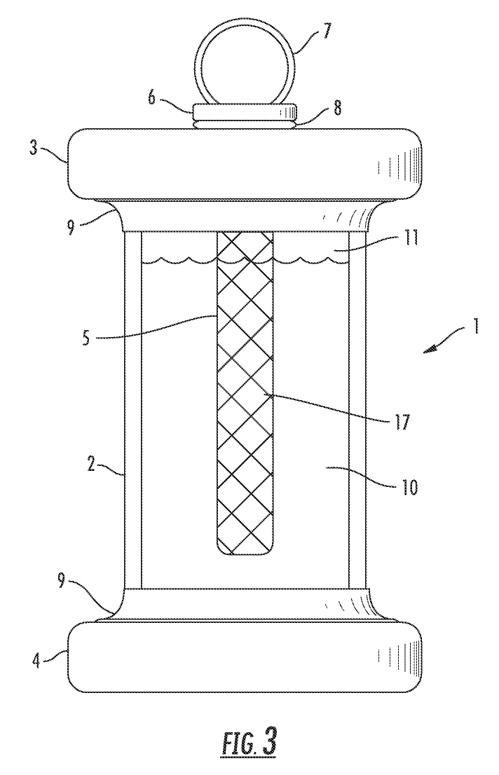

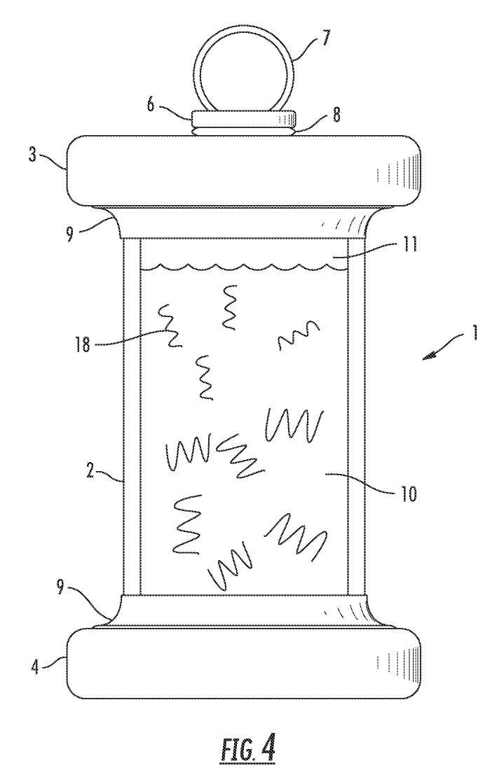

FIG. 4 is a front view of the third embodiment.

FIG. 5 is a front view of the fourth embodiment.

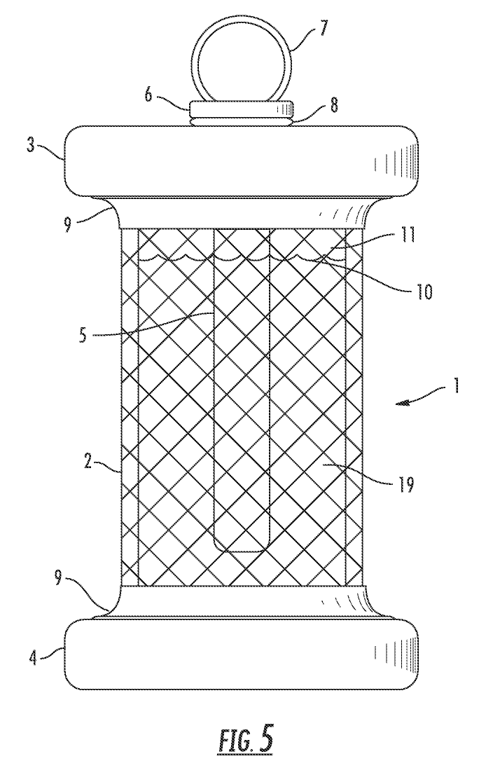

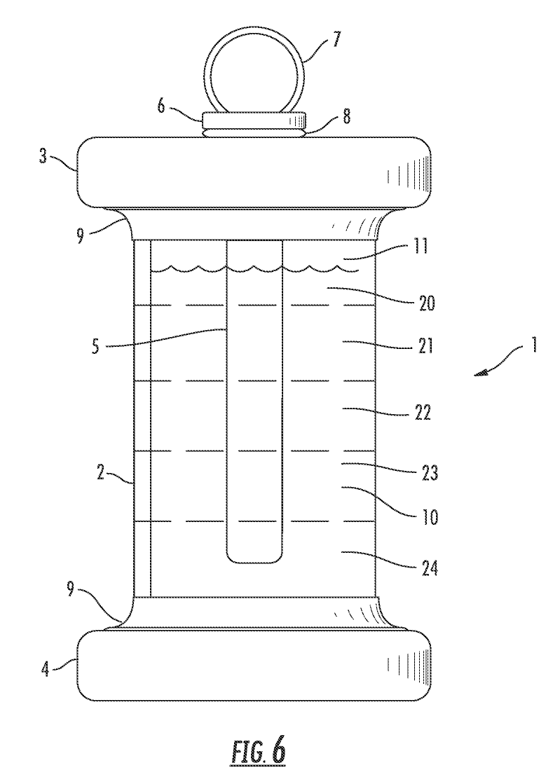

FIG. 6 is a front view of the fifth embodiment.

FIG. 7 is a front view of the sixth embodiment.

FIG. 8 is a perspective view of a plurality of devices used in an outdoor setting.

### DETAILED DESCRIPTION

The invention is a method and plurality of devices to repel flies from a building entrance or an outdoor area. The basic embodiment of the invention consists of a clear rigid housing sealed with at least one endcap which is filled with a clear transparent liquid. A reflective element is then inserted into the center of the housing and a plug is threaded to prevent evaporation of the liquid within. This invention may be hung on a wall or ceiling through the use of a hanging loop, or it may be placed on a surface such as a table top. Ambient light passes through the clear rigid housing and the liquid, reflects off the metallic element, and is refracted following Snell's Law, resulting in the prismatic effect. Changes in the refracted light disrupt the visual functions of flies, and they are repelled from the area.

For the purposes of promoting an understanding of the principles of the invention, reference will now be made to the specific embodiments, or examples, illustrated in the drawings. Though specific language will be used to describe the specific embodiments, it will nevertheless be understood that no limitation to the scope of the invention is intended. Any alterations and further modifications to the described embodiments, and any further applications of the principles of the invention as described herein are fully contemplated as would normally occur to one skilled in the art to which the invention relates.

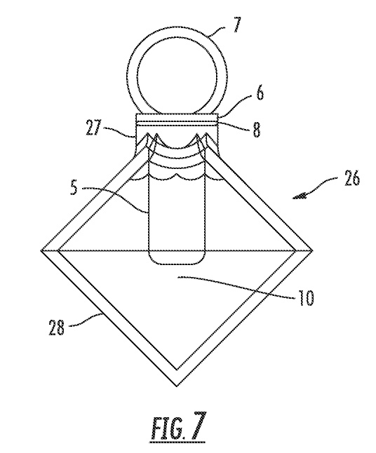

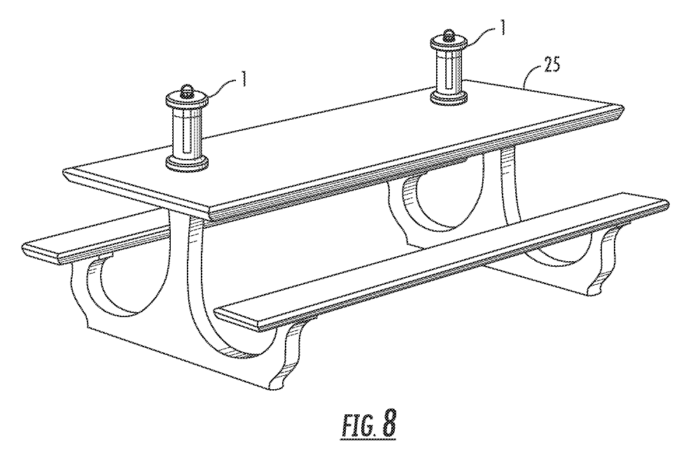

Referring initially to FIG. 1, an exploded perspective view of the repellant device 1 is shown. As depicted, the repellant device 1 is comprised of a cylindrical clear rigid housing 2 which is tubular in shape in this embodiment. The cylindrical clear rigid housing 2 is formed of any suitable material for use in outdoor settings. For example, but without limitation, cylindrical clear rigid housing 2 can be formed of polymeric materials (such as polycarbonate, acrylic, cellulose acetate butyrate, polyvinyl chloride, and other polymers), or ceramic materials (such as soda lime glass, laminated glass, tempered glass, borosilicate glass, or other ceramics). The invention is also comprised of one or more endcaps 3 and 4. The endcaps 3 and 4 may be formed of polymeric or metallic materials. Superior endcap 3 has a threaded hole 15 for filling and changing of the clear transparent liquid 10, shown in FIGS. 2-14. The threads in superior endcap 3 mate with the threaded section 14 on metallic element 12, allowing the metallic element 12 to be threaded into superior endcap 3. Both superior endcap 3 and inferior endcap 4 have a counterbore 16 which mates to cylindrical clear rigid housing 2. Counterbore 16 aligns endcaps 3 and 4 to cylindrical clear rigid housing 2 and fixates the endcaps to the housing by use of an interference fit. Alternatively, the ends of clear rigid housing 2 and the walls of the counterbore 16 may be threaded together or joined by another method known to one skilled in the art, such as ultrasonic welding or gluing. Waterproof seals 9, are placed over the joints between cylindrical clear rigid housing 2 and endcaps 3 and 4. These seals may be formed of silicone, epoxy, or another sealant known to one skilled in the art.

Reflective element 12 is comprised of metallic shaft 5, threaded region 14, proximal plug region 6, hanging mechanism 7, and engagement mechanism 13. The engagement mechanism 13 may be a hexagonal recess, a single recess for mating with a flathead-type screwdriver, a cross-shaped recess for mating with a Phillips-head-type screwdriver, any geometrical recess, any other type of recess for mating with a driver, and combinations thereof. The hanging mechanism 7, may be a mobile loop, a fixed loop, a hook, or any other projection for mating with a hanger. The proximal plug region 6 is an enlarged diameter region greater than the diameter of metallic shaft 5 and threaded hole 15. The metallic shaft 5 is the surface from which ambient light is reflected when the invention is used. Reflective element 12 may be formed from one or multiple components. In the preferred embodiment, reflective element 12 is machined from one piece of a corrosion resistant stainless steel such as Carpenter Custom 630 (17Cr-4Ni) Stainless Steel. The reflective element 12 may be formed of copper, titanium, aluminum, or another metallic element or alloy. In other embodiments, the proximal plug section 6 may be polymeric and glued to a stainless steel metallic shaft 5. The surface of the metallic shaft 5 may be passivated, electropolished, polished, anodized, or chrome coated to increase the amount of reflection from the surface.

Once sealed, repellant device 1 can be filled with a clear transparent fluid 10. Reflective element 12 can be passed through gasket 8 in order to create a waterproof seal once proximal plug region 6 is fully seated after being threaded into threaded hole 15 with assistance from a screwdriver engaging into engagement mechanism 13.

FIG. 2 shows repellant device 1 fully assembled. In the preferred embodiment, the clear transparent fluid 10 is distilled water. A chemical stabilizer such as liquid or dry chlorine may be added to prevent stagnation. The repellant device 1 may be assembled in a vacuum environment in order to create a vacuum within interior cavity 11 to prevent the growth of aerobic organisms. A vacuum may also be created through other methods such as those commonly used in canning foods.

FIG. 3 shows an embodiment with a plurality of facets 17 machined onto metallic shaft 5. The facets 17 create reflective surfaces at different angles which results in a magnification of the prismatic effect.

FIG. 4 shows an embodiment where metal turnings 18 are used as reflective elements within clear transparent liquid 10 instead of metallic shaft 5. The metal turnings 18 may be formed of stainless steel, copper, aluminum, titanium, or another metallic element or alloy. The metal turnings 18 may be passivated, chrome coated, or electropolished. In this embodiment, it may be necessary to add salt or another solute to the clear transparent liquid 10 in order to create a liquid density such that the metal turnings 18 will not sink to the bottom of interior cavity 11.

FIG. 5 shows an embodiment with a plurality of facets 19 machined onto cylindrical clear rigid housing 2. The facets 19 create refractive surfaces at different angles which results in a magnification of the prismatic effect.

FIG. 6 shows an embodiment with regions of varying refractive index 20-24 are found on clear rigid housing 2. FIG. 6 shows these regions in a horizontal orientation. It would also be possible to orient these regions in a vertical, diagonal, or random orientation. The varying refractive index regions 20-24 may be produced by various manufacturing techniques known to those skilled in the art, such as tempering, grinding, or etching. The varying refractive index regions 20-24 create different dispersion patterns of light, which may magnify the repellant effect of the invention.

FIG. 7 shows an aesthetic embodiment 26, for use on a front porch or next to the entrance to a building. In aesthetic embodiment 26, the cylindrical clear rigid housing 2 is replaced with a polyhedron shaped clear rigid housing, in this case an octahedron clear rigid housing 28. The octahedron clear rigid housing may be formed of the same materials as cylindrical clear rigid housing 2. Inferior endcap 4 is no longer necessary, and superior endcap 3 is replaced with octahedron superior endcap 27 in order to mate with the octahedron clear rigid housing 28. This embodiment illustrates how this invention may be designed with other three-dimensional geometric shapes not explicitly shown in this application.

FIG. 8 shows a plurality of repellant devices 1 on an outdoor table 25. Other recommended applications of this invention include hanging adjacent to building entrances, in restaurant kitchens, in horse stables, and in daycare centers.

What is claimed is:

1. A device to repel flies comprising a clear rigid housing with at least one endcap, filled with a clear transparent liquid, and at least one reflective element contained within.

2. The device of claim 1 wherein the clear rigid housing is cylindrical with two endcaps.

3. The device of claim 1 wherein the clear rigid housing is a polyhedron.

4. The device of claim 1 wherein the reflective element has a plurality of facets machined on its surface.

5. The device of claim 1 wherein the clear rigid housing has a plurality of facets machined on its surface.

6. The device of claim 1 wherein the reflective element is a rod.

7. The device of claim 1 wherein the reflective element is a tube.

8. The device of claim 1 wherein the reflective element is a plurality of metal turnings.

9. The device of claim 1 wherein the clear rigid housing has regions with different refractive indexes.

10. The device of claim 1 wherein a vacuum is formed within the clear rigid housing.
